(19) United States
(12) Patent Application Publication
(10) Pub. No.: US 2016/0082715 A1
(43) Pub. Date: Mar. 24, 2016

(54) SCREEN PRINTING MACHINE AND PRINTING METHOD THEREOF

(71) Applicant: SHENZHEN CHINA STAR OPTOELECTRONICS TECHNOLOGY CO., LTD., Shenzhen (CN)

(72) Inventor: Wei Yu, Shenzhen (CN)

(21) Appl. No.: 14/418,086

(22) PCT Filed: Dec. 29, 2014
(86) PCT No.: PCT/CN2014/095346

§ 371 Date: Jan. 29, 2015

(30) Foreign Application Priority Data
Sep. 24, 2014 (CN) 201410492320.3

(51) Int. Cl. B41F 15/08

(52) U.S. Cl. CPC B41F 15/085

(57) ABSTRACT

A screen printing machine is disclosed, which includes a mesh frame, a mesh, and a scraping blade. The mesh frame includes four sides. During printing, the scraping blade shifts from a first side of the mesh frame to an opposing second side. The screen printing machine further includes: a first lifting device located on the first side of the mesh frame, a second lifting device located on the second side of the frame, a detection module for detecting a position of the scraping blade, and a control device for adjusting the first lifting device and the second lifting device according to the position of the scraping blade. The mesh collapse is avoided, and the life of the mesh is extended.

### FIELD OF THE INVENTION

The present invention relates to the field of screen printing, and in particular to a screen printing machine and a printing method thereof.

### BACKGROUND OF THE INVENTION

Screen printing belongs to porous printing of four major categories of printing (relief printing, planographic printing, intaglio printing, and porous printing). In screen printing, silk, synthetic fibers, or metal fibers are woven into a mesh, which is bound to a mesh frame, and manufactured into a screen by methods of hand carving or photochemical engraving. Ink can pass through pores of the graphic part of the screen, and is leaked onto the carrier. The other parts form blanks on the carrier.

A cross-sectional schematic view of a screen is shown in FIG. 1A. For ensuring high print quality, a suitable distance is arranged between the mesh 13 and the carrier (glass) 11 during printing. In a typical machine, after the distance is arranged via the mesh frame 12, the positions thereof are fixed, and the distance is h. A schematic top view of the screen is shown in FIG. 1B. The screen is formed by fixing the spread mesh 13 onto the mesh frame 12. A cross-sectional schematic view of a screen during printing is shown in FIG. 1C. The scraping blade 14 presses downwards onto the mesh 13 to contact the glass 11, and the scraping blade 14 shifts, so that the ink on the screen is transferred onto the glass 11.

The periphery of the mesh 13 is fixed to the mesh frame 12, the peripheral area is tighter than the middle area, and the compression deformation caused is slight. However, the peripheral area also requires to be pressed downwards to contact the glass 11 by the scraping blade 14. The mesh will be collapsed with the increasing printing number, so that the mesh requires to be replaced with a new one, and the life of the mesh is shortened (typically scraping 2000 to 3000 times).

Therefore, reducing mesh deformation to avoid mesh collapse and prolong the life of the mesh has become a major research and development direction in screen printing technology.

### SUMMARY OF THE INVENTION

A primary object of the present invention is to provide a screening printing machine and a printing method thereof for reducing deformation of a mesh and for prolonging the life thereof by determining a position of a scraping blade and adaptively adjusting a distance between the mesh and a carrier.

To achieve the above object, an embodiment of the present invention provides following solutions:

A screen printing machine, comprising:
a mesh frame;
a mesh; and
a scraping blade;
the mesh frame having four sides,
wherein when the screen printing machine is printing, the first scraping blade shifts from a first side to an opposite second side of the mesh frame,
wherein the screen printing machine further comprises:
a first lifting device located on the first side of the mesh frame for lifting and lowering the first side;
a second lifting device located on the second side of the mesh frame for lifting and lowering the second side;
a detection module for detecting a position of the scraping blade; and
a control device for adjusting the first lifting device and the second lifting device according to the position of the scraping blade to lower the first side or the second side before the scraping blade presses downwards,
wherein the screen printing machine further comprises a stabilizing device for keeping a height of the center of the mesh unchanged,
when the scraping blade is located in the middle of the screen frame, the stabilizing device is used for keeping a height of the first side, a height of the second side, and the height of the center of the mesh equivalent, and
the control device controls the first lifting device, the second linear device, and the stabilizing device by a linear motor.

Preferably, when a distance between the scraping blade and the first side is smaller than a distance between the scraping blade and the second side, the control device lowers the first side for a predetermined distance by the first lifting device.

Preferably, when a distance between the scraping blade and the first side is greater than a distance between the scraping blade and the second side, the control device lowers the second side for a predetermined distance by the second lifting device.

Preferably, when a distance between the scraping blade and the first side is equivalent to a distance between the scraping blade and the second side, the control device keeps the height of the first side and the height of the second side equivalent by the stabilizing device.

Preferably, the position of the scraping blade is obtained according to an initial position, shifting speed, and shifting time of the scraping blade.

Preferably, the position of the scraping blade is obtained according to a control command of shifting of the scraping blade.

A screen printing machine, comprising:
a mesh frame;
a mesh; and
a scraping blade;
the mesh frame having four sides,
wherein when the screen printing machines is printing, the first scraping blade shifts from a first side to an opposite second side of the mesh frame,
wherein the screen printing machine further comprises:
a first lifting device located on the first side of the mesh frame for lifting and lowering the first side;
a second lifting device located on the second side of the mesh frame for lifting and lowering the second side;
a detection module for detecting a position of the scraping blade; and
a control device for adjusting the first lifting device and the second lifting device according to the position of the scraping blade to lower the first side or the second side before the scraping blade presses downwards.

Preferably, the screen printing machine further comprises a stabilizing device for keeping a height of the center of the mesh unchanged.

Preferably, when a distance between the scraping blade and the first side is smaller than a distance between the scraping blade and the second side, the control device lowers the first side by a predetermined distance by the first lifting device.

Preferably, when a distance between the scraping blade and the first side is greater than a distance between the scraping blade and the second side, the control device lowers the second side by a predetermined distance by the second lifting device.

Preferably, when a distance between the scraping blade and the first side is equivalent to a distance between the scraping blade and the second side, the control device keeps a height of the first side and a height of the second side equivalent by the stabilizing device.

Preferably, when the scraping blade is located in the middle of the screen frame, the stabilizing device is used for keeping a height of the first side, a height of the second side, and the height of the center of the mesh equivalent.

Preferably, the control device controls the first lifting device, the second linear device, and the stabilizing device by a linear motor.

Preferably, the position of the scraping blade is obtained according to an initial position, shifting speed and shifting time of the scraping blade.

Preferably, the position of the scraping blade is obtained according to a control command of shifting of the scraping blade.

A printing method of a screen printing machine, the screen printing machine including:
a mesh frame, a mesh, and a scraping blade, the mesh frame having four sides,
wherein the side with which the scraping blade begins is a first side, the side to which the first side is opposite is a second side, and the screen printing machine further comprises:
a first lifting device located on the first side of the mesh frame for lifting and lowering the first side;
a second lifting device located on the second side of the mesh frame for lifting and lowering the second side;
a detection module for detecting a position of the scraping blade; and
a control device for adjusting the first lifting device and the second lifting device according to the position of the scraping blade to the first side or the second side before the scraping blade presses downwards,
wherein the screen printing machine further comprises a stabilizing device for keeping a height of the center of the mesh unchanged,
wherein the printing method comprises the steps of:
adjusting the first lifting device and the second lifting device to an initial state;
obtaining a position of the scraping blade and determining a relative position between the scraping blade and the first side, and a relative position between the scraping blade and the second side;
when the scraping blade is closer to the first side, the control device lowers the first side by a predetermined distance by the first lifting device,
when the scraping blade is closer to the second side, the control device lowers the second side by a predetermined distance by the second lifting device,
when distances to the both sides are equivalent, the first lifting device and the second lifting device are adjusted to the initial state.

Preferably, in the initial state, distances in height from a carrier to the first side and to the second side are equivalent.

Preferably, the control device controls the first lifting device, the second linear device, and the stabilizing device by a linear motor.

Preferably, the step of obtaining the position of the scraping blade further comprises obtaining the position of the scraping blade according to an initial position, shifting speed, and shifting time of the scraping blade.

Preferably, the step of obtaining the position of the scraping blade further comprises obtaining the position of the scraping blade according to a control command of shifting of the scraping blade.

With respect to the prior art, the screen printing machine and the printing method in the present invention reduces the deformation of the mesh and prolongs the life of the mesh or even the screen by determining the position of the scraping blade and adaptively adjusting the distance between the mesh and the carrier.

To make the above content of this invention easily understood, preferred embodiments are provided below with reference to the accompanying drawings, and described in detail below.

### BRIEF DESCRIPTION OF THE DRAWINGS

FIG. 1A is a sectional schematic diagram of a screen in a screen printing device in the prior art.

FIG. 1B is a top schematic diagram of the screen in the screen printing device in the prior art.

FIG. 1C is a sectional schematic diagram of the screen in the screen printing device during printing in the prior art.

FIG. 2 is a schematic diagram of modules in a screen printing device in accordance with a first embodiment of the present invention.

FIG. 3A-FIG. 3C are schematic diagrams of adjustment of a screen in the screen printing device in the present invention when a scraping blade is in different positions.

FIG. 4A-FIG. 4C are sectional schematic diagrams of the screen corresponding to FIG. 3A-FIG. 3C when the scraping blade presses downwards.

FIG. 5 is a schematic flowchart of a printing method in accordance with a second embodiment of the present invention.

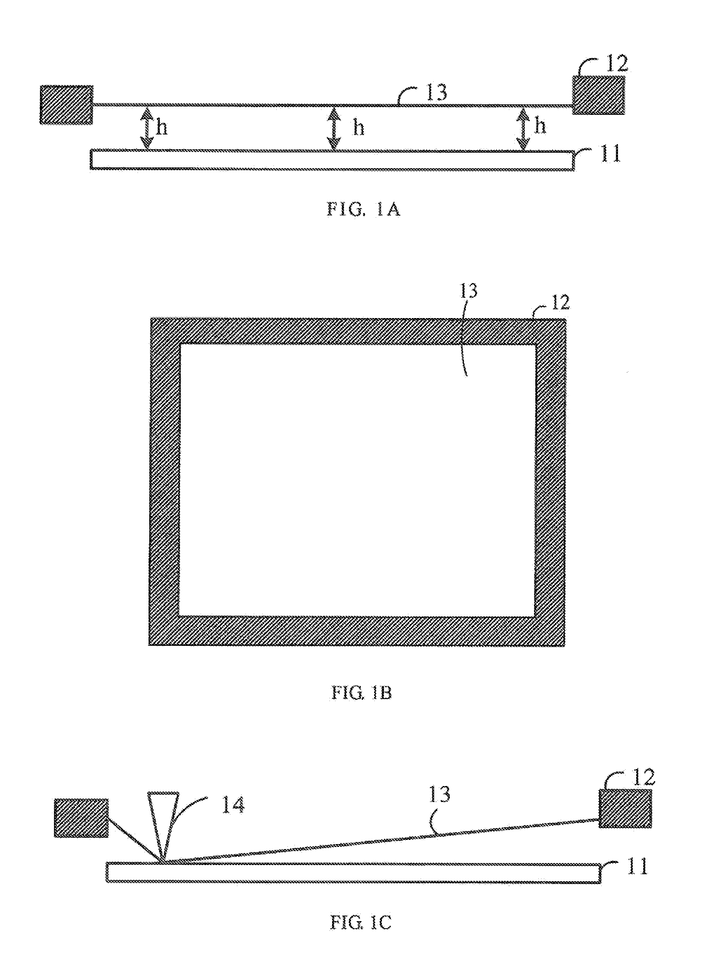

### DETAILED DESCRIPTION OF THE PREFERRED EMBODIMENTS

Please refer to the figures in the accompany drawings. The components with the same reference numbers represent the same or similar components. The following description is based on the illustrated specific embodiments of the present invention, and should not be construed to limit the other specific embodiments which are not described in detail herein.

### First Embodiment

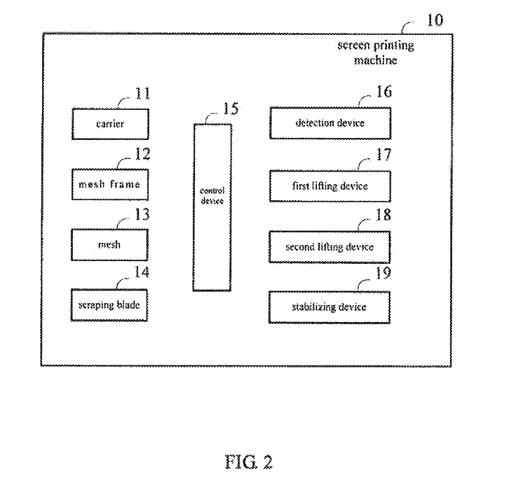

Please refer to FIG. 2, which is a schematic diagram of a screen printing machine provided by an embodiment of the present invention.

A screen printing machine 10 in the present invention includes a carrier 11, a mesh frame 12, a mesh 13, a scraping blade 14, a control device 15, a detection device 16, a first lifting device 17, a second lifting device 18, and a stabilizing device 19.

The carrier 11 is typically glass for supporting an object to be printed, such as paper, cloth, and the like.

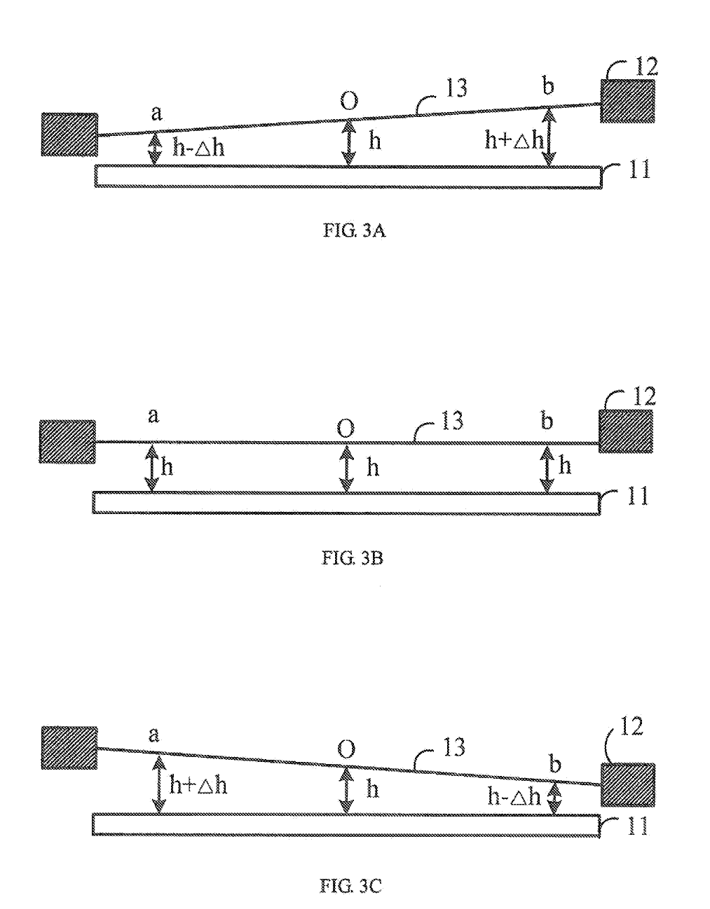

The mesh frame 12 is typically a rectangle having four sides. During printing, the scraping blade 14 shifts from a first side a to an opposing second side b of the mesh frame 12, as shown in FIG. 3A.

The mesh 13 is the core component in the screen printing. The number, the diameter, the thickness, the pore size, and the loaded ink of the mesh are important parameters of the screen printing. Meanwhile, the diameter, the weaving method and the chosen material of the mesh also directly affect the tension of the mesh.

As shown in FIG. 3A-FIG. 3C, the distance between the mesh 13 and the carrier 11 should be within the endurable range or the appropriately-endured range of the tension of the mesh 13. Typically, the distance is measured starting at a distance 10 cm away from a side of the mesh, which is an initial position and a terminal position of the scraping blade.

The detection module 16 is used for detecting or determining the position of the scraping blade 14.

It should be understood that, as shown in FIG. 3A-FIG. 3C, the lifting and lowering principle of the first lifting device 17, the second lifting device 18, and the stabilizing device 19 is similar to a “seesaw”. The stabilizing device 19 is used for keeping the height of the center of the mesh 13 constant; the first lifting device 17 and the second lifting device 18 are used for applying a force to the mesh frame 12 and for positioning the same.

A control device adjusts the first lifting device and the second lifting device according to the position of the scraping blade o lower the first side or the second side before the scraping blade presses downwards.

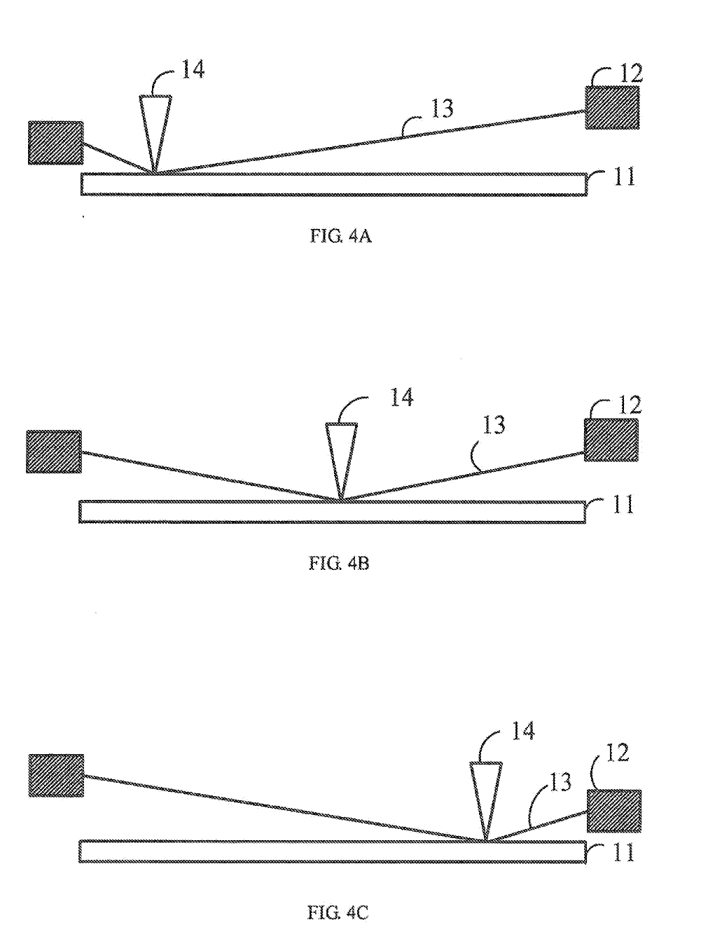

Specifically, as shown in FIG. 3A and FIG. 4A, when the distance between the scraping blade 14 and the first side a is smaller than the distance between the scraping blade and the second side b, the control device 15 lowers the first side for a predetermined distance by the first lifting device 17. That is, before the scraping blade 14 presses downward, the distance in height of the first side at a mesh measurement point is h−Δh, the height of the second side at a mesh measurement point is h+Δh, and the height of the center is h. The mesh measurement point refers to the actual initial point of the scraping blade 10 cm away from the inner side of the mesh frame.

As shown in FIG. 3B and FIG. 4B, when the scraping blade 14 is located in the middle of the screen frame, the stabilizing device 19 is used for keeping the height of the first side a, the height of the second side b, and the height of the center of the mesh equivalent.

As shown in FIG. 3C and FIG. 4C, when the distance between the scraping blade 14 and the first side a is greater than the distance between the scraping blade and the second side b, the control device 15 lowers the first side for a predetermined distance by the second lifting device 18. That is, before the scraping blade 14 presses downwards, the distance in height of the first side at a mesh measurement point is h+Δh, the height of the second side at a mesh measurement point is h−Δh, and the height of the center ◯ is h.

The control device 15 controls the first lifting device, the second linear device, and the stabilizing device by a linear motor.

It should be understood that, compared with the rotary motor, the linear motor has a simple structure, precise positioning, and high sensitivity. A variety of linear motors are suitable to use, so the specific structure of the linear motor is not described redundantly.

With respect to the prior art, the screen printing machine and the printing method in the present invention reduces the deformation of the mesh and prolongs the life of the mesh or even the screen by determining the position of the scraping blade and adaptively adjusting the distance between the mesh and the carrier.

### Second Embodiment

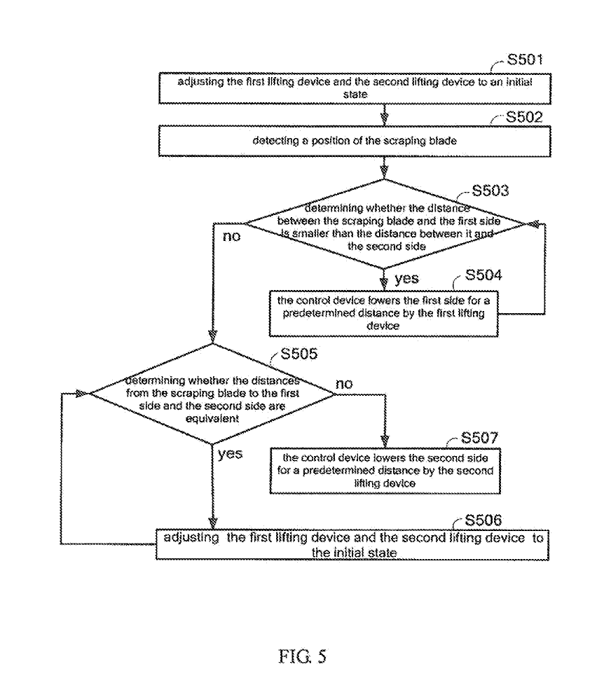

Please refer to FIG. 5, which shows a printing method of a screen printing machine in an embodiment. The screen printing machine includes a carrier, a mesh frame, a mesh, a scraping blade, a control device, a detection device, a first lifting device, a second lifting device 18, and a stabilizing device. The mesh frame includes four sides. The side with which the scraping blade begins is a first side, and the side to which the first side is opposite is a second side.

The printing method includes following steps.

In step S501, the first lifting device and the second lifting device are adjusted to an initial state.

It should be understood that the heights of the first side and the second side away from the carrier are equivalent in the initial state.

In step S502, a position of the scraping blade is obtained.

It should be understood that the position of the scraping blade can be obtained via the initial position of the scraping blade, shifting speed, and shifting time, or can he obtained by analyzing a control command which is received with shifting of the scraping blade.

In step S503, whether the distance between the scraping blade and the first side is smaller than the distance between the scraping blade and the second side is determined, wherein when it is smaller, step S504 is executed, and when it is not smaller, step S505 is executed.

In step S504, when the scraping blade is closer to the first side, the control device lowers the first side for a predetermined distance by the first lifting device.

Please refer to FIG. 3A and FIG. 4A. When the distance between the scraping blade 14 and the first side a is smaller than the distance between the scraping blade 14 and the second side b, the control device 15 lowers the first side for a predetermined distance by the first lifting device 17. That is, before the scraping blade 14 presses downwards, the distance in height of the first side at a mesh measurement point is h−Δh, the height of the second side at a mesh measurement point is h+Δh, and the height of the center is h.

In step S505, whether the scraping blade shifts to a point from which the distances to the first side and the second side are equivalent is determined continuously, wherein when it is equivalent, step S506 is executed, and when it is not equivalent, step S507 is executed.

In step S506, when the distances to the both sides are equivalent, the first lifting device and the second lifting device are adjusted to the initial state.

Please refer to FIG. 3B and FIG. 4B. When the scraping blade 14 is located in the middle of the screen frame 12, the stabilizing device 19 is used for keeping the height of the first side a, the height of the second side b, and the height of the center ◯ of the mesh 13 equivalent.

In step S507, when the scraping blade is closer to the second side, the control device lowers the second side for a predetermined distance by the second lifting device.

Please refer to FIG. 3A and FIG. 4A. When the distance between the scraping blade 14 and the first side a is greater than the distance between the scraping blade 14 and the second side b, the control device 15 lowers the first side for a predetermined distance by the second lifting device 18. That is, before the scraping blade 14 presses downwards, the distance in height of the first side at a mesh measurement point is h+Δh, the height of the second side at a mesh measurement point is h−Δh, and the height of the center ◯ is h.

With respect to the prior art, the screen printing machine and the printing method in the present invention reduces the deformation of the mesh and prolongs the life of the mesh or even the screen by determining the position of the scraping blade and adaptively adjusting the distance between the mesh and the carrier.

In summary, although the preferable embodiments of the present invention have been disclosed above, the embodiments are not intended to limit the present invention. A person of ordinary skill in the art, without departing from the spirit and scope of the present invention, can make various modifications and variations. Therefore, the scopes of the invention are defined in the claims.

What is claimed is:

1. A screen printing machine, comprising:
a mesh frame;
a mesh; and
a scraping blade;
the mesh frame having four sides,
wherein when the screen printing machine is printing, the first scraping blade shifts from a first side to an opposite second side of the mesh frame,
wherein the screen printing machine further comprises:
a first lifting device located on the first side of the mesh frame for lifting and lowering the first side;
a second lifting device located on the second side of the mesh frame for lifting and lowering the second side;
a detection module for detecting a position of the scraping blade; and
a control device for adjusting the first lifting device and the second lifting device according to the position of the scraping blade to lower the first side or the second side before the scraping blade presses downwards,
wherein the screen printing machine further comprises a stabilizing device for keeping a height of the center of the mesh unchanged,
when the scraping blade is located in the middle of the screen frame, the stabilizing device is used for keeping a height of the first side, a height of the second side, and the height of the center of the mesh equivalent, and
the control device controls the first lifting device, the second linear device, and the stabilizing device by a linear motor.

2. The screen printing machine as claimed in claim 1, wherein when a distance between the scraping blade and the first side is smaller than a distance between the scraping blade and the second side, the control device lowers the first side for a predetermined distance by the first lifting device.

3. The screen printing machine as claimed in claim 1, wherein when a distance between the scraping blade and the first side is greater than a distance between the scraping blade and the second side, the control device lowers the second side for a predetermined distance by the second lifting device.

4. The screen printing machine as claimed in claim 1, wherein when a distance between the scraping blade and the first side is equivalent to a distance between the scraping blade and the second side, the control device keeps the height of the first side and the height of the second side equivalent by the stabilizing device.

5. The screen printing machine as claimed in claim 1, wherein the position of the scraping blade is obtained according to an initial position, shifting speed and shifting time of the scraping blade.

6. The screen printing machine as claimed in claim 1, wherein the position of the scraping blade is obtained according to a control command of shifting the scraping blade.

7. A screen printing machine, comprising:
a mesh frame;
a mesh; and
a scraping blade;
the mesh frame having four sides,
wherein when the screen printing machines is printing, the first scraping blade shifts from a first side to an opposite second side of the mesh frame,
wherein the screen printing machine further comprises:
a first lifting device located on the first side of the mesh frame for lifting and lowering the first side;
a second lifting device located on the second side of the mesh frame for lifting and lowering the second side;
a detection module for detecting a position of the scraping blade; and
a control device for adjusting the first lifting device and the second lifting device according to the position of the scraping blade, to lower the first side or the second side before the scraping blade presses downward.

8. The screen printing machine as claimed in claim 7, wherein the screen printing machine further comprises a stabilizing device for keeping a height of the center of the mesh unchanged.

9. The screen printing machine as claimed in claim 7, wherein when a distance between the scraping blade and the first side is smaller than a distance between the scraping blade and the second side, the control device lowers the first side for a predetermined distance by the first lifting device.

10. The screen printing machine as claimed in claim 7, wherein when a distance between the scraping blade and the first side is greater than a distance between the scraping blade and the second side, the control device lowers the second side for a predetermined distance by the second lifting device.

11. The screen printing machine as claimed in claim 8, wherein when a distance between the scraping blade and the first side is equivalent to a distance between the scraping blade and the second side, the control device keeps a height of the first side and a height of the second side equivalent by the stabilizing device.

12. The screen printing machine as claimed in claim 8, wherein when the scraping blade is located in the middle of the screen frame, the stabilizing device is used for keeping a height of the first side, a height of the second side, and the height of the center of the mesh equivalent.

13. The screen printing machine as claimed in claim 8, wherein the control device controls the first lifting device, the second linear device, and the stabilizing device by a linear motor.

14. The screen printing machine as claimed in claim 8, wherein the position of the scraping blade is obtained according to an initial position, shifting speed and shifting time of the scraping blade.

15. The screen printing machine as claimed in claim 8, wherein the position of the scraping blade is obtained according to a control command of shifting of the scraping blade.

16. A printing method of a screen printing machine, the screen printing machine including:
a mesh frame, a mesh, and a scraping blade, the mesh frame having four sides,
wherein the side with which the scraping blade begins is a first side, the side to which the first side is opposite is a second side, and the screen printing machine further comprises:
a first lifting device located on the first side of the mesh frame for lifting and lowering the first side;
a second lifting device located on the second side of the mesh frame for lifting and lowering the second side;
a detection module for detecting a position of the scraping blade; and
a control device for adjusting the first lifting device and the second lifting device according to the position of the scraping blade to lower the first side or the second side before the scraping blade presses downwards,
wherein the screen printing machine further comprises a stabilizing device for keeping a height of the center of the mesh unchanged,
wherein the printing method comprises the steps of:
adjusting the first lifting device and the second lifting device to an initial state;
obtaining a position of the scraping blade and determining a relative position between the scraping blade and the first side and a relative position between the scraping blade and the second side;
when the scraping blade is closer to the first side, the control device lowers the first side for a predetermined distance by the first lifting device,
when the scraping blade is closer to the second side, the control device lowers the second side for a predetermined distance by the second lifting device,
when distances to the both sides are equivalent, the first lifting device and the second lifting device are adjusted to the initial state.

17. The printing method as claimed in claim 16, wherein in the initial state, distances height from a carrier to the first side and to the second side are equivalent.

18. The printing method as claimed in claim 16, wherein the control device controls the first lifting device, the second linear device, and the stabilizing device by a linear motor.

19. The printing method as claimed in claim 16, wherein the step of obtaining the position of the scraping blade further comprises obtaining the position of the scraping blade according to an initial position, shifting speed and shifting time of the scraping blade.

20. The printing method as claimed in claim 16, wherein the step of obtaining the position of the scraping blade further comprises obtaining the position of the scraping blade according to a control command of shifting of the scraping blade.
